(19) United States
(12) Patent Application Publication
(10) Pub. No.: US 2021/0042350 A1
(43) Pub. Date: Feb. 11, 2021

(54) SYSTEMS AND METHODS FOR IMAGE ARCHIVING

(71) Applicant: SHANGHAI TRUTHVISION INFORMATION TECHNOLOGY CO., LTD., Shanghai (CN)

(72) Inventor: Zhong ZHANG, Great Falls, VA (US)

(73) Assignee: SHANGHAI TRUTHVISION INFORMATION TECHNOLOGY CO., LTD., Shanghai (CN)

(21) Appl. No.: 17/080,868

(22) Filed: Oct. 27, 2020

Related U.S. Application Data
(63) Continuation of application No. PCT/CN2019/084430, filed on Apr. 26, 2019.
(60) Provisional application No. 62/664,068, filed on Apr. 27, 2018.

(51) Int. Cl. G06F 16/58; G06F 16/583; G06F 16/903; G06T 7/73

(52) U.S. Cl. CPC G06F 16/5866; G06F 16/583; G06T 2207/10004; G06T 7/73; G06F 16/90348

(57) ABSTRACT

The present disclosure relates to systems and methods for retrieving image data. The systems may obtain a search request from a user device, the search request including at least one keyword. The systems may identify, in an image database, one or more target image archives associated with one or more target tags, respectively. The systems may retrieve, from the image database, the one or more target image archives, each of the one or more target image archives including a plurality of target images. The systems may transmit the one or more target image archives to the user device to be displayed via a user interface of the user device.

### CROSS-REFERENCE TO RELATED APPLICATIONS

This application is a continuation of International Application No. PCT/CN2019/084430, filed on Apr. 26, 2019, which claims priority of U.S. provisional Patent Application No. 62/664,068 filed on Apr. 27, 2018, the contents of which are incorporated herein by reference in their entirety.

### TECHNICAL FIELD

The present disclosure generally relates to systems and methods for image archiving, and in particular, to systems and methods for image archiving based on feature information of images.

### BACKGROUND

Image archiving is an important hot spot in various fields. For image archiving in family scenario (e.g., a daily life record), an image archiving system may capture and store a large amount of images every day. The capturing of the images may be triggered by various factors such as a detected object or an event. However, it is difficult for a user to identify a target image from the large amount of images or to flexibly group the images into different categories or folders. Therefore, it is desirable to provide systems and methods for automatically archiving images based on different features of the images and retrieving target images based on keywords included in search requests from a user.

### SUMMARY

An aspect of the present disclosure relates to a system for retrieving image data. The system may include at least one storage medium including a set of instructions and at least one processor in communication with the at least one storage medium. When executing the set of instructions, the at least one processor may be configured to cause the system to perform one or more of the following operations. The at least one processor may obtain a search request from a user device, the search request including at least one keyword. The at least one processor may identify, in an image database, one or more target image archives associated with one or more target tags, respectively. The at least one processor may retrieve, from the image database, the one or more target image archives, each of the one or more target image archives including a plurality of target images. The at least one processor may transmit the one or more target image archives to the user device to be displayed via a user interface of the user device.

Another aspect of the present disclosure relates to a method implemented on a computing device having at least one processor, at least one storage medium, and a communication platform connected to a network. The method may include one or more of the following operations. The at least one processor may obtain a search request from a user device, the search request including at least one keyword. The at least one processor may identify, in an image database, one or more target image archives associated with one or more target tags, respectively. The at least one processor may retrieve, from the image database, the one or more target image archives, each of the one or more target image archives including a plurality of target images. The at least one processor may transmit the one or more target image archives to the user device to be displayed via a user interface of the user device.

A further aspect of the present disclosure relates to a non-transitory computer readable medium including executable instructions. When the executable instructions are executed by at least one processor, the executable instructions may direct the at least one processor to perform a method. The method may include one or more of the following operations. The at least one processor may obtain a search request from a user device, the search request including at least one keyword. The at least one processor may identify, in an image database, one or more target image archives associated with one or more target tags, respectively. The at least one processor may retrieve, from the image database, the one or more target image archives, each of the one or more target image archives including a plurality of target images. The at least one processor may transmit the one or more target image archives to the user device to be displayed via a user interface of the user device.

In some embodiments, the at least one processor may obtain a plurality of images from a camera device. For each of the plurality of images, the at least one processor may determine feature information of the image and determine one or more tags associated with the image based on the feature information. The at least one processor may generate one or more image archives based on the plurality of images and a plurality of tags associated with the plurality of images.

In some embodiments, the feature information may include at least one of object information, expression information, event information, time information, and/or location information.

In some embodiments, for at least two images of the plurality of images, the at least one processor may determine that the at least two images direct to a same tag and correlate the at least two images based on the same tag.

In some embodiments, the at least one processor may obtain an image captured by a camera device. The at least one processor may determine feature information of the image. The at least one processor may determine one or more tags associated with the image based on the feature information. The at least one processor may identify one or more image archives associated with the one or more tags, respectively. The at least one processor may archive, in the image database, the image to the one or more image archives, respectively.

In some embodiments, the search request may be associated with at least one of a text input, an audio input, an image input, and/or a video input.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary image auto-archiving system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device according to some embodiments of the present disclosure;

FIG. 4 is a block diagram illustrating an exemplary processing engine according to some embodiments of the present disclosure;

FIG. 5 is a block diagram illustrating an exemplary feature determination module and an exemplary tag determination module according to some embodiments of the present disclosure;

FIG. 6 is a flowchart illustrating an exemplary process for determining one or more image archives according to some embodiments of the present disclosure;

FIG. 7 is a flowchart illustrating an exemplary process for determining one or more target image archives based on a search request according to some embodiments of the present disclosure;

FIG. 8 is a schematic diagram illustrating an exemplary user interface for an image auto-archiving system according to some embodiments of the present disclosure; and

FIG. 9 is a schematic diagram illustrating an exemplary user interface for displaying target image archives in response to a search request according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of steps, operations, elements, and/or components, but do not preclude the presence or addition of one or more other steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

An aspect of the present disclosure relates to systems and methods for establishing an image database. The systems and methods may obtain a plurality of images (e.g., a still image, a video) from a camera device. For each of the plurality of images, the systems and methods may determine feature information (e.g., object information, expression information, event information) of the image and determine one or more tags (e.g., a description associated with the feature information) associated with the image based on the feature information. The systems and methods may further determine one or more image archives based on the plurality of images and a plurality of tags associated with the plurality of images. Accordingly, the systems and methods may establish the image database based on the one or more image archives.

Another aspect of the present disclosure relates to systems and methods for retrieving target image archives from the image database based on a search request from a user. The systems and methods may obtain a search request including one or more keywords from a user device (e.g., a smart phone). The systems and methods may determine one or more target tags based on the one or more keywords and identify one or more target image archives associated with the one or more target tags in the image database. Further, the systems and methods may retrieve the one or more target image archives from the image database and transmit the one or more target image archives to the user device to be displayed via a user interface of the user device.

The systems and methods may automatically and efficiently determine tags for the captured images, and identify target image archives in response to a search request based on the tags. Accordingly, the systems and methods provide a solution for a user to search for any target image based on a search request including one or more keywords.

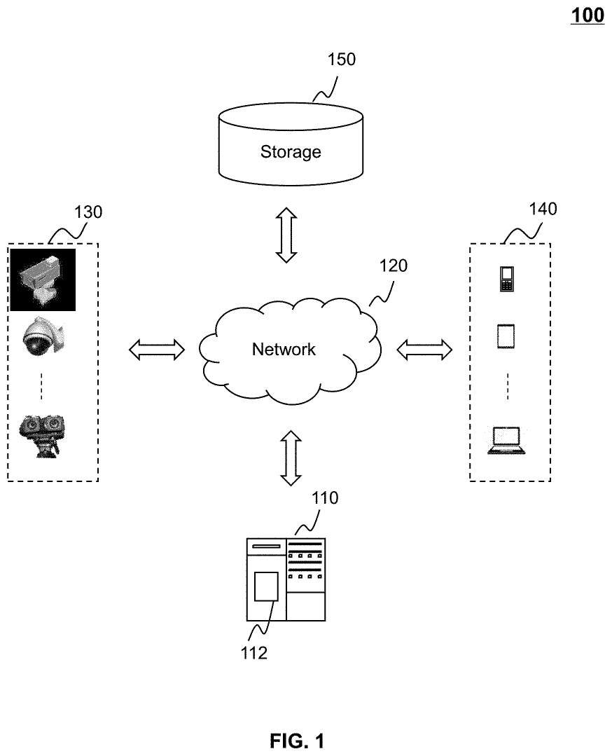

FIG. 1 is a schematic diagram illustrating an exemplary image auto-archiving system according to some embodiments of the present disclosure. The image auto-archiving system 100 may include a server 110, a network 120, a camera device 130, a user device 140, and a storage 150.

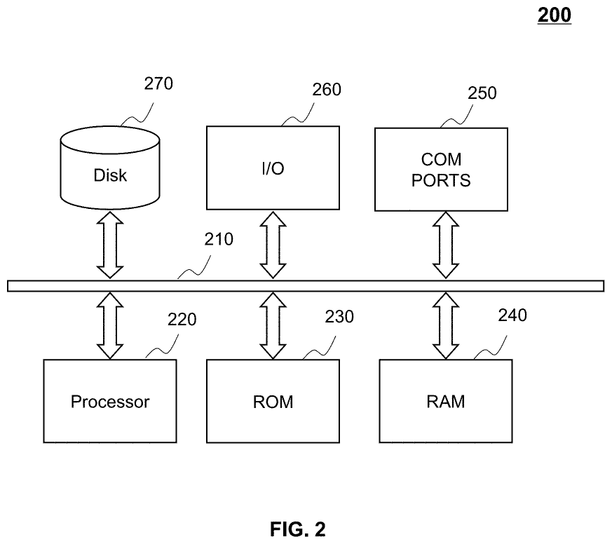

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the camera device 130, the user device 140, and/or the storage 150 via the network 120. As another example, the server 110 may be directly connected to the camera device 130, the user device 140, and/or the storage 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data to perform one or more functions described in the present disclosure. For example, the processing engine 112 may obtain one or more images from the camera device 130 and determine one or more tags associated with each of the one or more images based on feature information of the one or more images. In some embodiments, the processing engine 112 may include one or more processing engines (e.g., signal-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the auto-archiving system 100 (e.g., the server 110, the camera device 130, the user device 140, or the storage 150) may transmit information and/data to other component(s) of the image auto-archiving system 100 via the network 120. For example, the server 110 may receive a plurality of images from the camera device 130 via the network 120. In some embodiments, the network 120 may be any type of wired or wireless network, or any combination thereof. Merely by way of example, the network 120 may include a cable network, a wireline network, an optical fiber network, a tele communications network, an intranet, an internet, a local area network (LAN), a wide area network (WAN), a wireless local area network (WLAN), a metropolitan area network (MAN), a public telephone switched network (PTSN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the image auto-archiving system 100 may be connected to the network 120 to exchange data and/or information between them.

The camera device 130 may be configured to capture images associated with one or more objects. As used herein, the “image” may refer to a static image, a series of image frames, a video, etc. The object may include a person, an animal, a facility, a furniture, a decoration, etc. In some embodiments, the camera device 130 may include a spherical camera, a hemispherical camera, a rifle camera, etc. In some embodiments, the camera device 130 may include a black-white camera, a color camera, an infrared camera, an X-ray camera, etc. In some embodiments, the camera device 130 may include a digital camera, an analog camera, etc. In some embodiments, the camera device 130 may include a monocular camera, a binocular camera, a multi-camera, etc. In some embodiments, the camera device 130 may be an IP camera which can transmit the captured images to any component (e.g., the server 110, the user device 140, the storage 150) of the image auto-archiving system 100 via the network 120.

In some embodiments, the camera device 130 may automatically start a capture process in response to a first triggering event (e.g., a detection of a specific object) and stop the capture process in response to a second triggering event (e.g., a disappearance of the specific object). In some embodiments, the camera device 130 may automatically determine capture parameters (e.g., a brightness, a focal length, a capture time interval, an exposure time, a contrast, a saturation) based on characteristics of a scene or a target object. For example, the camera device 130 may automatically adjust the brightness based on a light (e.g., sunlight, lamplight, low light) of the scene. As another example, the camera device 130 may automatically adjust the capture time interval based on a type of the target object. For a moving target object, the capture time interval may be relatively short for an ordinary person in the art; whereas for a still target object, the capture time interval may be relatively long for an ordinary person in the art. As a further example, the camera device 130 may automatically adjust the exposure time based on a type of the scene. For a landscape photography, the exposure time may be relatively long for an ordinary person in the art; whereas for a portrait photography, the exposure time may be relatively short for an ordinary person in the art.

In some embodiments, the camera device 130 may include a built-in clock or communicate with an external clock which can record time information associated with images captured by the camera device 130. In some embodiments, the camera device 130 may include a positioning module with positioning technology for locating the position of the camera device 130. The positioning technology may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof.

In some embodiments, the images captured by the camera device 130 may be stored in a local storage device (not shown) in the camera device 130 or a remote storage device (e.g., the storage 150, a cloud storage) associated with the image auto-archiving system 100. In some embodiments, both the local storage device and the remote storage device may be encrypted based on an encryption algorithm (e.g., Advanced Encryption Standard Algorithm, Digital Signature Algorithm). One or more components of the image auto-archiving system 100 may access the storage device via a secret key. In some embodiments, one or more components of the image auto-archiving system 100 may have permissions to access the storage device. For example, a registered user device can access the storage device via registration information (e.g., a user name, a password, a face recognition, a voice recognition, a fingerprint).

The user device 140 may be connected to and/or communicate with the camera device 130, the processing engine 112, and/or the storage 150. The user device 140 include a mobile device, a tablet computer, a laptop computer, or the like, or any combination thereof. In some embodiments, the mobile device may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, some functions of the server 110 may be implemented by the user device 140.

The storage 150 may store data and/or instructions. In some embodiments, the storage 150 may store data obtained from the camera device 130, the user device 140, and/or the processing engine 112. For example, the storage 150 may store a plurality of images obtained from the camera device 130. As another example, the storage 150 may store one or more tags associated with an image determined by the processing engine 112. In some embodiments, the storage 150 may store data and/or instructions that the server 110 may execute or use to perform exemplary methods described in the present disclosure. For example, the storage 150 may store instructions that the processing engine 112 may execute or use to determine feature information of an image and one or more tags associated with the image. In some embodiments, the storage 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components of the image auto-archiving system 100 (e.g., the server 110, the camera device 130, or the user device 140). One or more components of the image auto-archiving system 100 may access the data and/or instructions stored in the storage 150 via the network 120. In some embodiments, the storage 150 may be directly connected to or communicate with one or more components (e.g., the server 110, the camera device 130, the user device 140) of the image auto-archiving system 100. In some embodiments, the storage 150 may be part of the server 110.

This description is intended to be illustrative, and not to limit the scope of the present disclosure. Many alternatives, modifications, and variations will be apparent to those skilled in the art. The features, structures, methods, and other characteristics of the exemplary embodiments described herein may be combined in various ways to obtain additional and/or alternative exemplary embodiments. However, those variations and modifications do not depart the scope of the present disclosure.

FIG. 2 is a schematic diagram illustrating exemplary hardware and software components of a computing device 200 on which the server 110, the user device 140 may be implemented according to some embodiments of the present disclosure. For example, the processing engine 112 may be implemented on the computing device 200 and configured to perform functions of the processing engine 112 disclosed in this disclosure.

The computing device 200 may be used to implement any component of the image auto-archiving system 100 as described herein. For example, the processing engine 112 may be implemented on the computing device 200, via its hardware, software program, firmware, or a combination thereof. Although only one such computer is shown, for convenience, the computer functions relating to the auto-archiving service as described herein may be implemented in a distributed fashion on a number of similar platforms to distribute the processing load.

The computing device 200, for example, may include COM ports 250 connected to and from a network connected thereto to facilitate data communications. The computing device 200 may also include a processor 220, in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, and a read only memory (ROM) 230, or a random access memory (RAM) 240, for various data files to be processed and/or transmitted by the computing device. The exemplary computer platform may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one processor is described in FIG. 2. Multiple processors are also contemplated, thus operations and/or method steps performed by one processor as described in the present disclosure may also be jointly or separately performed by the multiple processors. For example, if in the present disclosure the processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

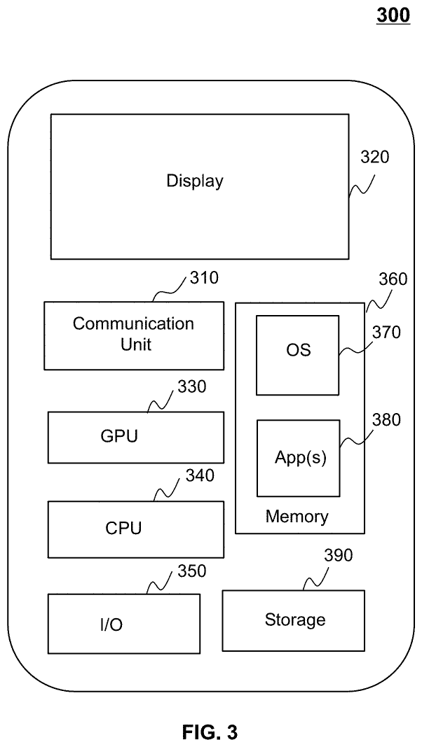

FIG. 3 is a schematic diagram illustrating exemplary hardware and/or software components of a mobile device 300 on which the user device 140 may be implemented according to some embodiments of the present disclosure. As illustrated in FIG. 3, the mobile device 300 may include a communication unit 310, a display 320, a graphic processing unit (GPU) 330, a central processing unit (CPU) 340, an I/O 350, a memory 360, a mobile operating system (OS) 370, and a storage 390. The CPU 340 may include interface circuits and processing circuits similar to the processor 220. In some embodiments, any other suitable component, including but not limited to a system bus or a controller (not shown), may also be included in the mobile device 300.

In some embodiments, the mobile operating system (OS) 370 (e.g., iOS™ Android™, Windows Phone™, etc.) and one or more application(s) 380 may be loaded into the memory 360 from the storage 390 in order to be executed by the CPU 340. The application(s) 380 may include a browser or any other suitable mobile apps for receiving and rendering information relating to a service request or other information from the location based service providing system on the mobile device 300. User interactions with the information stream may be achieved via the I/O devices 350 and provided to the processing engine 112 and/or other components of the system 100 via the network 120.

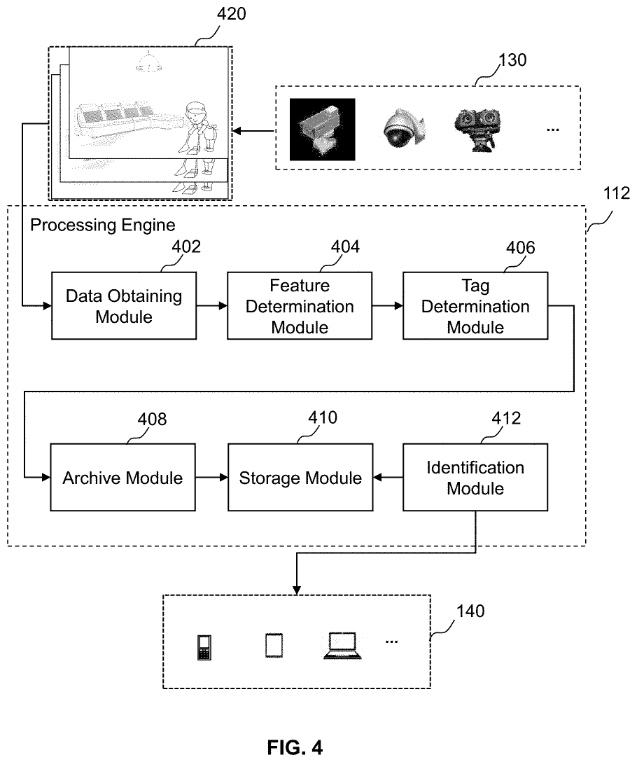

FIG. 4 is a block diagram illustrating an exemplary processing engine according to some embodiments of the present disclosure. The processing engine 112 may include a data obtaining module 402, a feature determination module 404, a tag determination module 406, an archive module 408, a storage module 410, and an identification module 412.

The data obtaining module 402 may be configured to obtain a plurality of images (e.g., 420 illustrated in FIG. 4). As used herein, the “image” may refer to a static image, a series of image frames, a video, etc. The image may be a two-dimensional image, a three-dimensional image, a four-dimensional image, etc. The image may further include voice information associated with the image. The data obtaining module 402 may obtain the plurality of images from a camera device (e.g., the camera device 130) periodically (e.g., per second, per 2 seconds, per 5 seconds, per 10 seconds) or in real time. In some embodiments, during the capturing of the images, the camera device 130 may transmit the images to a storage device (e.g., the storage 150) periodically (e.g., per second, per 2 seconds, per 5 seconds, per 10 seconds) or in real time via the network 120. Further, the data obtaining module 402 may access the storage device and retrieve the images.

The feature determination module 404 may be configured to determine feature information of each of the plurality of images. The feature determination module 404 may determine the feature information of the plurality of images via a plurality of threads or a plurality of computing nodes. The feature information may include object information, expression information, event information, time information, location information, or the like, or any combination thereof. In some embodiments, before determining the feature information of the image, the feature determination module 404 may preprocess the image. For example, the feature determination module 404 may enlarge a specific region in the image to identify a region of interest (ROI). As another example, the feature determination module 404 may reduce noise(s) in the image based on a noise reduction technique (e.g., a wavelet noise reduction technique). As a further example, the feature determination module 404 may compress the image to increase the processing speed.

The tag determination module 406 may be configured to determine one or more tags associated with each of the plurality of images based on the feature information. As used herein, a “tag” may refer to a description (e.g., a keyword, a term, a sentence) associated with the feature information of the image. Take a family scenario as an example, assuming that the feature information of an image includes object information of a family member A and a family member B, expression information (e.g., “happiness”), event information (e.g., “wedding anniversary”), the tag determination module 406 may determine tags “A,” “B,” “happiness,” “wedding anniversary” associated with the image. As another example, assuming that the feature information of an image includes object information (e.g., clothing) of a family member C, the tag determination module 406 may determine tags “C,” “white long dress” associated with the image.

The archive module 408 may be configured to determine one or more image archives based on the plurality of images and the one or more tags associated with each of the plurality of images. As used herein, an “image archive” may refer to a collection of one or more images corresponding to a same tag.

In some embodiments, after determining the one or more image archives, the archive module 408 may further establish an image database in a storage device (e.g., the storage 150) disclosed elsewhere in the present disclosure based on the one or more image archives. In some embodiments, the archive module 408 may identify the one or more image archives from an existing image database in a storage device (e.g., the storage 150) disclosed elsewhere in the present disclosure based on the one or more tags associated with each of the plurality of images and archive the plurality of images to the one or more image archives.

The storage module 410 may be configured to store any information and/or data associated with the modules in the processing engine 112. For example, the storage module 410 may store the feature information of the plurality of images, the tag of the images, and/or the image archives. As described elsewhere in the present disclosure, the storage module 410 may include any suitable storage device which may perform storage function.

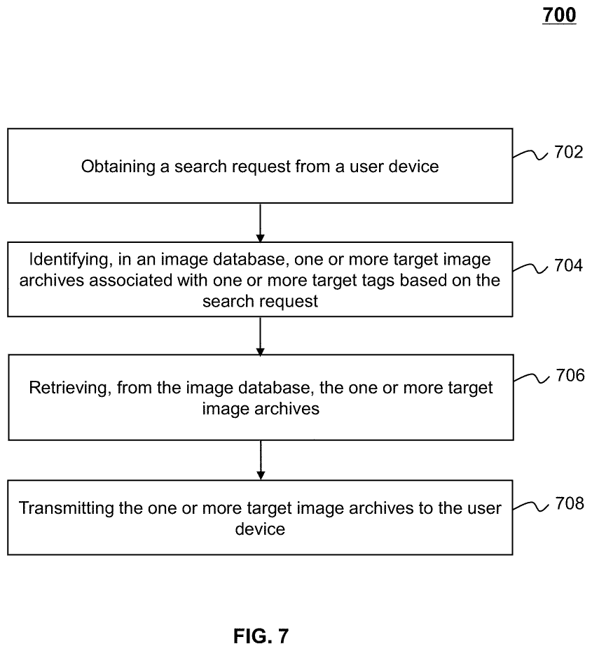

The identification module 412 may be configured to obtain a search request from the user device 140, identify one or more target image archives associated with one or more target tags based on the search request in an image database, retrieve the one or more target image archives from the image database, and transmit the one or more target image archives to the user device 140 via the network 120. More descriptions may be found elsewhere in the present disclosure (e.g., FIG. 7 and the description thereof).

The modules in the processing engine 112 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined into a single module, and any one of the modules may be divided into two or more units. For example, the storage module 410 may be unnecessary and the processing engine 112 may store the information and/or data in a storage device (e.g., the storage 150) disclosed elsewhere in the present disclosure.

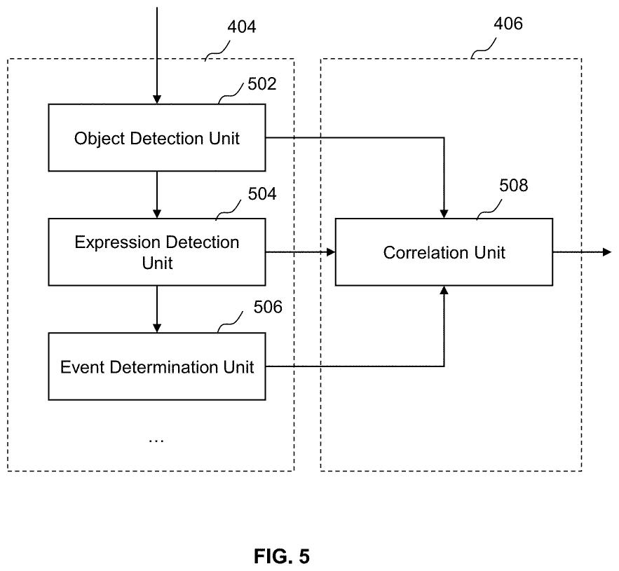

FIG. 5 is a block diagram illustrating an exemplary feature determination module and an exemplary tag determination module according to some embodiments of the present disclosure. The feature determination module 404 may include an object detection unit 502, an expression determination unit 504, and an event determination unit 506. The tag determination module 406 may include a correlation unit 508.

The object detection unit 502 may be configured to detect object information of the plurality of images. The object information may indicate general information associated with object(s) in the images. As described elsewhere in the present disclosure, the object in the image may include a person, an animal, a facility, a furniture, a decoration, etc. Take the “person” as an example, the object information may include identification information (e.g., a name, an ID number), a height, a weight, an age, a gender, clothing (e.g., color, style), etc. Also take the “furniture (e.g., a dining-table)” as an example, the object information may include purchase information (e.g., price, purchase time), a length, a width, a height, a weight, a color, etc. In some embodiments, the object detection unit 502 may first detect the object(s) in the images and further extract the object information. The object detection unit 502 may detect the object(s) in the images based on an object detection algorithm (e.g., an inter-frame difference algorithm, a background difference algorithm, an optical flow algorithm). After detecting the object(s) in the images, the object detection unit 502 may extract the object information corresponding to the object(s).

The expression determination unit 504 may be configured to detect expression information of the plurality of images. The expression information may indicate emotional expression and/or action expression of the object(s) in the images. The emotional expression may include happiness, anger, disgust, fear, sadness, etc. The action expression may include sleep, watching TV, work, reading, cooking, cleaning, etc. Take the “emotional expression” as an example, the expression determination unit 504 may identify a facial feature (e.g., a wrinkle, a muscle change, a shape of an organ (e.g., eyes)) of the object (e.g., a person) and determine the emotional expression based on the facial feature. In some embodiments, the expression determination unit 504 may identify the facial feature of the object based on a feature extraction algorithm. Exemplary feature extraction algorithm may include a principal component analysis (PCA), a linear discriminant analysis (LDA), an independent component analysis (ICA), a multi-dimensional scaling (MDS) algorithm, a discrete cosine transform (DCT) algorithm, etc. As described elsewhere in the present disclosure, the expression determination unit 504 may further determine the emotional expression based on the facial feature according to a machine learning model (e.g., a neural network model, a regression model, a classification tree model).

The event determination unit 506 may be configured to detect event information of the plurality of images. The event information may indicate a date section (e.g., a birthday) and/or an activity (e.g., a birthday party) associated with the image. For example, the event information may include a New Year's Day, a Spring Festival, a Christmas Day, a Halloween, a wedding anniversary, a Christmas dinner, a home party, etc. In some embodiments, the event determination unit 506 may obtain the event information from a built-in calendar system in the auto-archiving system 100. For example, a user may manually set a special date (e.g., a birthday, an anniversary) in the calendar system and the event determination unit 506 may access the calendar system to retrieve the event information. In some embodiments, the event determination unit 506 may obtain the event information from an external resource (e.g., a news platform, an online calendar) via the network 120. In some embodiments, the event determination unit 506 may determine the event information (e.g., a birthday party) by identifying and/or analyzing a typical characteristic (e.g., a cake, a candle, a bubbly) in the image.

The correlation unit 508 may be configured to correlate two or more images of the plurality of images based on the tags associated with the images. For example, assuming that both a first image and a second image correspond to a same tag “wedding anniversary,” the correlation unit 508 may correlate the two images via a correlation word “wedding anniversary.”

The units in the feature determination module 404 and the tag determination module 406 may be connected to or communicated with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the units may be combined into a single units, and any one of the units may be divided into two or more sub-units. For example, the feature determination module 404 may further include other units (e.g., a time determination unit) configured to determine other feature information of the plurality of images.

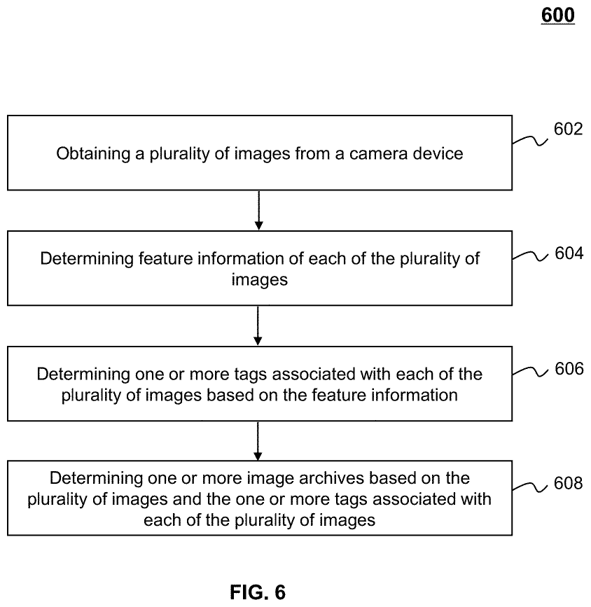

FIG. 6 is a flowchart illustrating an exemplary process for determining one or more image archives according to some embodiments of the present disclosure. The process 600 may be executed by the image auto-archiving system 100. For example, the process 600 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 600. The operations of the illustrated process presented below are intended to be illustrative. In some embodiments, the process 600 may be accomplished with one or more additional operations not described and/or without one or more of the operations discussed. Additionally, the order in which the operations of the process 600 as illustrated in FIG. 6 and described below is not intended to be limiting.

In 602, the processing engine 112 (e.g., the data obtaining module 402) (e.g., the interface circuits of the processor 220) may obtain a plurality of images. As used herein, the “image” may refer to a static image, a series of image frames, a video, etc. The image may be a two-dimensional image, a three-dimensional image, a four-dimensional image, etc. The image may further include voice information associated with the image.

In some embodiments, the processing engine 112 may obtain the plurality of images from a camera device (e.g., the camera device 130) periodically (e.g., per second, per 2 seconds, per 5 seconds, per 10 seconds) or in real time. In some embodiments, during the capturing of the images, the camera device 130 may transmit the images to a storage device (e.g., the storage 150) periodically (e.g., per second, per 2 seconds, per 5 seconds, per 10 seconds) or in real time via the network 120. Further, the processing engine 112 may access the storage device and retrieve the images.

In 604, the processing engine 112 (e.g., the feature determination module 404) (e.g., the processing circuits of the processor 220) may determine feature information of each of the plurality of images. The processing engine 112 may determine the feature information of the plurality of images via a plurality of threads or a plurality of computing nodes. The feature information may include object information, expression information, event information, time information, location information, or the like, or any combination thereof.

The object information may indicate general information associated with object(s) in the images. As described elsewhere in the present disclosure, the object in the image may include a person, an animal, a facility, a furniture, a decoration, etc. Take the “person” as an example, the object information may include identification information (e.g., a name, an ID number), a height, a weight, an age, a gender, clothing (e.g., color, style), etc. Also take the “furniture (e.g., a dining-table)” as an example, the object information may include purchase information (e.g., price, purchase time), a length, a width, a height, a weight, a color, etc.

The processing engine 112 may first detect the object(s) in the images and further extract the object information. The processing engine 112 may detect the object(s) in the images based on an object detection algorithm (e.g., an inter-frame difference algorithm, a background difference algorithm, an optical flow algorithm). After detecting the object(s) in the images, the processing engine 112 may extract the object information corresponding to the object(s). Take a specific object as an example, some of the object information (e.g., identification information, gender) may be directly obtained from registration information of the specific object. In this situation, the processing engine 112 may access a storage device (e.g., the storage 150) associated with the image auto-archiving system 100 to obtain the registration information. Otherwise, some of the object information may be obtained indirectly by analyzing the detected object. For example, the processing engine 112 may determine the object information such as the weight, the height, the color of clothing, based on a machine learning model (e.g., a neural network model, a regression model, a classification tree model).

The expression information may indicate emotional expression and/or action expression of the object(s) in the images. The emotional expression may include happiness, anger, disgust, fear, sadness, etc. The action expression may include sleep, watching TV, work, reading, cooking, cleaning, etc. Take the “emotional expression” as an example, the processing engine 112 may identify a facial feature (e.g., a wrinkle, a muscle change, a shape of an organ (e.g., eyes)) of the object (e.g., a person) and determine the emotional expression based on the facial feature. In some embodiments, the processing engine 112 may identify the facial feature of the object based on a feature extraction algorithm. Exemplary feature extraction algorithm may include a principal component analysis (PCA), a linear discriminant analysis (LDA), an independent component analysis (ICA), a multi-dimensional scaling (MDS) algorithm, a discrete cosine transform (DCT) algorithm, etc. As described elsewhere in the present disclosure, the processing engine 112 may further determine the emotional expression based on the facial feature according to a machine learning model (e.g., a neural network model, a regression model, a classification tree model).

The event information may indicate a date section (e.g., a birthday) and/or an activity (e.g., a birthday party) associated with the image. For example, the event information may include a New Year's Day, a Spring Festival, a Christmas Day, a Halloween, a wedding anniversary, a Christmas dinner, a home party, etc. In some embodiments, the processing engine 112 may obtain the event information from a built-in calendar system in the auto-archiving system 100. For example, a user may manually set a special date (e.g., a birthday, an anniversary) in the calendar system and the processing engine 112 may access the calendar system to retrieve the event information. In some embodiments, the processing engine 112 may obtain the event information from an external resource (e.g., a news platform, an online calendar) via the network 120. In some embodiments, the processing engine 112 may determine the event information (e.g., a birthday party) by identifying and/or analyzing a typical characteristic (e.g., a cake, a candle, a bubbly) in the image.

The time information may indicate a time (e.g., a data, a time period, a time point) when the image was captured. The location information may indicate a location where the image was captured. Take a family scenario as an example, the location information may include a living room, a bedroom, a kitchen, a dining room, a study, etc. As described elsewhere in the present disclosure, the camera device 130 may include a positioning module which can determine the location of the camera device 130.

In some embodiments, before determining the feature information of the image, the processing engine 112 may preprocess the image. For example, the processing engine 112 may enlarge a specific region in the image to identify a region of interest (ROI). As another example, the processing engine 112 may reduce noise(s) in the image based on a noise reduction technique (e.g., a wavelet noise reduction technique). As a further example, the processing engine 112 may compress the image to increase the processing speed.

In 606, the processing engine 112 (e.g., the tag determination module 406) (e.g., the processing circuits of the processor 220) may determine one or more tags associated with each of the plurality of images based on the feature information. As used herein, a “tag” may refer to a description (e.g., a keyword, a term, a sentence) associated with the feature information of the image. Take a family scenario as an example, assuming that the feature information of an image includes object information of a family member A and a family member B, expression information (e.g., “happiness”), event information (e.g., “wedding anniversary”), the processing engine 112 may determine tags “A,” “B,” “happiness,” “wedding anniversary” associated with the image. As another example, assuming that the feature information of an image includes object information (e.g., clothing) of a family member C, the processing engine 112 may determine tags “C,” “white long dress” associated with the image.

In some embodiments, the processing engine 112 may correlate two or more images of the plurality of images based on the tags associated with the images. For example, assuming that both a first image and a second image correspond to a same tag “wedding anniversary,” the processing engine 112 may correlate the two images via a correlation word “wedding anniversary.”

In 608, the processing engine 112 (e.g., the archive module 408) (e.g., the processing circuits of the processor 220) may determine one or more image archives based on the plurality of images and the one or more tags associated with each of the plurality of images. As used herein, an “image archive” may refer to a collection of one or more images corresponding to a same tag.

In some embodiments, after determining the one or more image archives, the processing engine 112 may further establish an image database in a storage device (e.g., the storage 150) disclosed elsewhere in the present disclosure based on the one or more image archives. In some embodiments, the processing engine 112 may identify the one or more image archives from an existing image database in a storage device (e.g., the storage 150) disclosed elsewhere in the present disclosure based on the one or more tags associated with each of the plurality of images and archive the plurality of images to the one or more image archives.

For illustration purposes, the present disclosure takes “the plurality of images” as an example, it should be noted that the processing engine 112 may obtain images one by one in real time from the camera device 130. The processing engine 112 may process the images in real time via a plurality of threads or a plurality of computing nodes. For example, assuming that the processing engine 112 obtains an image A₁ from the camera device 130 at a time point T₁, the processing engine 112 may process the image A₁ via a thread X₁; the processing engine 112 further obtains an image A₂ from the camera device 130 at a time point T₂ (the image A₁ is still under processing at the moment), the processing may process the image A₂ via a thread X₂; and so on. When the processing of an image is completed, the corresponding thread may be idle and the thread may be assigned a next task. In this way, the processing engine 112 may obtain and process images simultaneously.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more steps (e.g., a storing step) may be added elsewhere in the process 600. In the storing step, the processing engine 112 may store information and/or data associated with the images (e.g., the feature information of the images, the one or more tags associated with the images) in a storage device (e.g., the storage 150) disclosed elsewhere in the present disclosure. As another example, step 604 and step 606 may be combined as a single step in which the processing engine 112 may both determine the feature information of each of the plurality of images and determine the one or more tags associated with each of the plurality of images based on the feature information.

FIG. 7 is a flowchart illustrating an exemplary process for determining one or more target image archives based on a search request according to some embodiments of the present disclosure. The process 700 may be executed by the image auto-archiving system 100. For example, the process 700 may be implemented as a set of instructions stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations discussed. Additionally, the order in which the operations of the process 700 as illustrated in FIG. 7 and described below is not intended to be limiting.

In 702, the processing engine 112 (e.g., the identification module 412) (e.g., the interface circuits of the processor 220) may obtain a search request from the user device 140. The processing engine 112 may obtain the search request from the user device 140 via the network 120. The search request may be associated with a text input, an image input, a video input, a voice input, etc. The search request may include one or more keywords. For example, the processing engine 112 may obtain a voice input from a user and identify the one or more keywords from the voice input based on a voice recognition technique (e.g., a voice model, a language model).

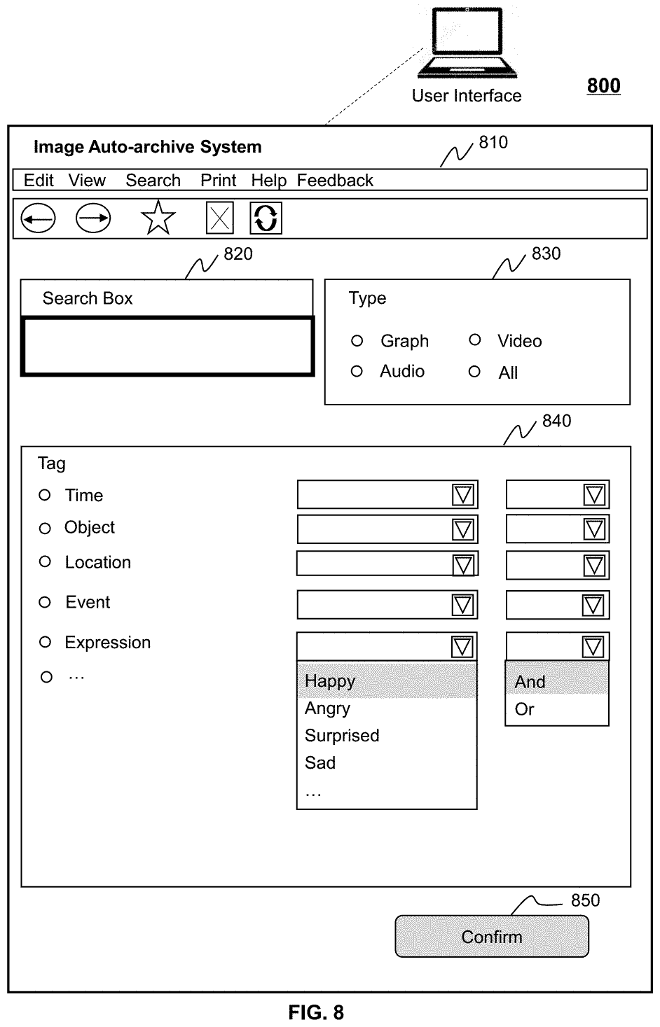

In some embodiments, the user device 140 may establish a communication (e.g., a wireless communication) with the processing engine 112 through an application (e.g., the application 380) associated with the image auto-archiving system 100 installed in the user device 140. Further, a user can initiate the search request via a user interface (e.g., a user interface 800 illustrated in FIG. 8) of the application. For example, the user may input a search query including one or more keywords via a search box 820 illustrated in FIG. 8. As another example, the user may initiate the search request by selecting one or more options via one or more option sections (e.g., 830 and 840 illustrated in FIG. 8). More descriptions of the user interface may be found elsewhere in the present disclosure (e.g., FIG. 8 and the description thereof).

In 704, the processing engine 112 (e.g., the identification module 412) (e.g., the processing circuits of the processor 220) may identify one or more target image archives associated with one or more target tags based on the search request in an image database (e.g., the image database described in FIG. 6).

In some embodiments, the processing engine 112 may identify the one or more target tags based on the one or more keywords included in the search request and identify the one or more target image archives based on the one or more target tags. For example, assuming that the search request includes one keyword inputted by the user, the processing engine 112 may identify a target tag that is the same as or substantially similar to the keyword. As used herein, “substantially similar” refers to that a similarity between the keyword and the target tag is larger than a threshold (e.g., 98%, 95%, 90%, 85%) or the keyword is a synonym of the target tag. Further, the processing engine 112 may identify the target image archive corresponding to the target tag in the image database. As another example, the user may select one or more target tags via one or more option sections of the user interface (e.g., 830 and 840 illustrated in FIG. 8). Further, the processing engine 112 may identify the one or more target image archives corresponding to the one or more target tags in the image database.

In 706, the processing engine 112 (e.g., the identification module 412) (e.g., the processing circuits of the processor 220) may retrieve the one or more target image archives from the image database.

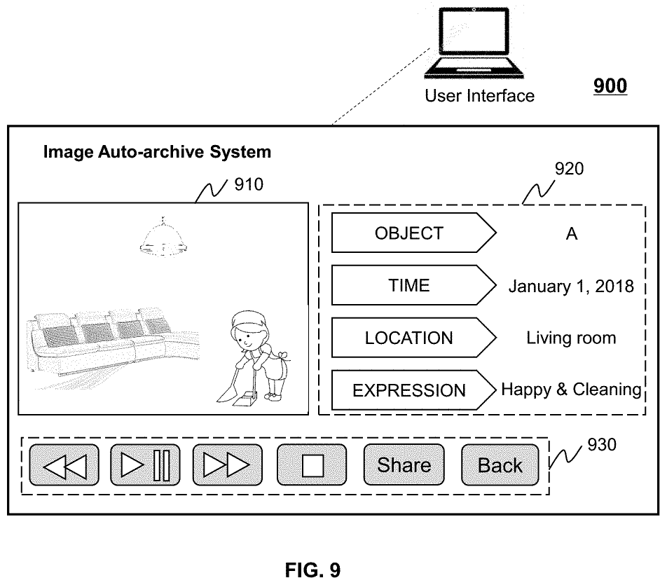

In 708, the processing engine 112 (e.g., the identification module 412) (e.g., the interface circuits of the processor 220) may transmit the one or more target image archives to the user device 140 via the network 120. The processing engine 112 may transmit the one or more target image archives via any suitable communication protocol (e.g., Address Resolution Protocol (ARP), Dynamic Host Configuration Protocol (DHCP), File Transfer Protocol (FTP), Hypertext Transfer Protocol (HTTP)). After receiving the one or more target image archives, the user device 140 may display the target image archives via a user interface (e.g., a user interface 900 illustrated in FIG. 9) of the application. The user device 140 may display the target image archives in the form of graph, audio, video, or the like, or a combination thereof.

It should be noted that the above description is merely provided for the purpose of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the process 700. In the storing step, the processing engine 112 may store information and/or data associated with the target image archives in a storage device (e.g., the storage 150) disclosed elsewhere in the present disclosure.

FIG. 8 is a schematic diagram illustrating an exemplary user interface for an image auto-archiving system according to some embodiments of the present disclosure. The user interface 800 may include one or more user interface elements (also referred to as “UI elements”) for presenting information associated with the image auto-archiving system. The UI elements may include one or more buttons, icons, checkboxes, message boxes, text fields, data fields, search fields, etc.

As illustrated, the user interface 800 may include a menu bar 810 for presenting operations (e.g., “edit,” “view,” “search,” “print,” “help,” “feedback”) associated with the system. The user interface 800 may also include a search box 820 for presenting a search query inputted by a user. The user can input one or more keywords in the search box 820 to initiate a search request. The user interface 800 may further include a type option section 830 for presenting various types (e.g., “graph,” “video,” “audio”) of the target image archives to be searched for. The user interface 800 may further include a tag option section 840 for presenting various types (e.g., “time,” “object,” “location,” “event,” “expression”) of tags that can be selected by the user to initiate a search request. For each type (e.g., “expression”), the tag option section 840 may include a pull-down list (“happy,” “angry,” “surprised,” “sad”), a text box, etc. The user can initiate a search request by selecting a plurality of tags and defining a relationship (e.g., “and,” “or”) among the plurality of selected tags via the tag option section 840. The user interface 800 may further include a button 850 for presenting a confirmation by the user.

FIG. 9 is a schematic diagram illustrating an exemplary user interface for displaying target image archives in response to a search request according to some embodiments of the present disclosure. The user interface 900 may include one or more UI elements for presenting selection options for a user to view and edit the target image archive(s).

As illustrated, the user interface 900 may include a display screen 910 for displaying the target image archive(s). The user interface 900 may also include a tag section 920 for presenting various tags associated with the target image archive(s). The user interface 900 may further include a function button section 930 for presenting operations (e.g., “fast forward,” “play,” “fast backward,” “stop,” “share,” “back”) associated with the target image archive(s).

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python, or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for retrieving image data, comprising:
at least one storage medium including a set of instructions;
at least one processor in communication with the at least one storage medium, wherein when executing the set of instructions, the at least one processor is configured to cause the system to:
obtain a search request from a user device, the search request including at least one keyword;
identify, in an image database, one or more target image archives associated with one or more target tags respectively based on the at least one keyword;
retrieve, from the image database, the one or more target image archives, each of the one or more target image archives including a plurality of target images; and
transmit the one or more target image archives to the user device to be displayed via a user interface of the user device.

2. The system of claim 1, wherein the at least one processor is configured to cause the system further to establish the image database, and
wherein to establish the image database, the at least one processor is configured to cause the system further to:
obtain a plurality of images from a camera device;
for each of the plurality of images,
determine feature information of the image; and
determine one or more tags associated with the image based on the feature information; and
generate one or more image archives based on the plurality of images and a plurality of tags associated with the plurality of images.

3. The system of claim 2, wherein the feature information includes at least one of object information, expression information, event information, time information, or location information.

4. The system of claim 2, wherein to establish the image database, the at least one processor is configured to cause the system further to:
for at least two images of the plurality of images,
determine that the at least two images direct to a same tag; and
correlate the at least two images based on the same tag.

5. The system of claim 1, wherein the at least one processor is configured to cause the system further to establish the image database, and
wherein to establish the image database, the at least one processor is configured to cause the system further to:
obtain an image captured by a camera device;
determine feature information of the image;
determine one or more tags associated with the image based on the feature information;
identify one or more image archives associated with the one or more tags, respectively; and
archive, in the image database, the image to the one or more image archives, respectively.

6. The system of claim 1, wherein the search request is associated with at least one of a text input, an audio input, an image input, or a video input.

7. A method implemented on a computing device having at least one processor, at least one storage medium, and a communication platform connected to a network, the method comprising:
obtaining a search request from a user device, the search request including at least one keyword;
identifying, in an image database, one or more target image archives associated with one or more target tags respectively based on the at least one keyword;
retrieving, from the image database, the one or more target image archives, each of the one or more target image archives including a plurality of target images; and
transmitting the one or more target image archives to the user device to be displayed via a user interface of the user device.

8. The method of claim 7, wherein the method further includes establishing the image database, the establishing the image database including:
obtaining a plurality of images from a camera device;
for each of the plurality of images,
determining feature information of the image; and
determining one or more tags associated with the image based on the feature information; and
generating one or more image archives based on the plurality of images and a plurality of tags associated with the plurality of images.

9. The method of claim 8, wherein the feature information includes at least one of object information, expression information, event information, time information, or location information.

10. The method of claim 8, wherein the establishing the image database includes:
for at least two images of the plurality of images,
determining that the at least two images direct to a same tag; and
correlating the at least two images based on the same tag.

11. The method of claim 7, wherein the method further includes establishing the image database, the establishing the image database including:
obtaining an image captured by a camera device;
determining feature information of the image;
determining one or more tags associated with the image based on the feature information;
identifying one or more image archives associated with the one or more tags, respectively; and
archiving, in the image database, the image to the one or more image archives, respectively.

12. The method of claim 7, wherein the search request is associated with at least one of a text input, an audio input, an image input, or a video input.

13. A non-transitory computer readable medium, comprising executable instructions that, when executed by at least one processor, directs the at least one processor to perform a method, the method comprising:
obtaining a search request from a user device, the search request including at least one keyword;
identifying, in an image database, one or more target image archives associated with one or more target tags respectively based on the at least one keyword;
retrieving, from the image database, the one or more target image archives, each of the one or more target image archives including a plurality of target images; and
transmitting the one or more target image archives to the user device to be displayed via a user interface of the user device.

14. The non-transitory computer readable medium of claim 13, wherein the method further includes establishing the image database, the establishing the image database including:
obtaining a plurality of images from a camera device;
for each of the plurality of images,
determining feature information of the image; and
determining one or more tags associated with the image based on the feature information; and
generating one or more image archives based on the plurality of images and a plurality of tags associated with the plurality of images.

15. The non-transitory computer readable medium of claim 14, wherein the feature information includes at least one of object information, expression information, event information, time information, or location information.

16. The non-transitory computer readable medium of claim 14, wherein the establishing the image database includes:
for at least two images of the plurality of images,
determining that the at least two images direct to a same tag; and
correlating the at least two images based on the same tag.

17. The non-transitory computer readable medium of claim 13, wherein the method further includes establishing the image database, the establishing the image database including:
obtaining an image captured by a camera device;
determining feature information of the image;
determining one or more tags associated with the image based on the feature information;
identifying one or more image archives associated with the one or more tags, respectively; and
archiving, in the image database, the image to the one or more image archives, respectively.

18. The non-transitory computer readable medium of claim 13, wherein the search request is associated with at least one of a text input, an audio input, an image input, or a video input.
